(19) United States
(12) Patent Application Publication
(10) Pub. No.: US 2007/0037549 A1
(43) Pub. Date: Feb. 15, 2007

(54) Apparatus and method for providing emergency broadcast information via a media playing device

(76) Inventor: Alexander I. Poltorak, Monsey, NY (US)

Correspondence Address: MEYERTONS, HOOD, KIVLIN, KOWERT & GOETZEL, P.C., 700 LAVACA, SUITE 800, AUSTIN, TX, 78701, US

(21) Appl. No.: 11/491,548

(22) Filed: Jul. 21, 2006

Related U.S. Application Data
(63) Continuation of application No. 10/147,024, filed on May 16, 2002, now abandoned.

(51) Int. Cl. H04M 11/04

(52) U.S. Cl. 455/404.1

(57) ABSTRACT

An apparatus and method for providing emergency broadcast information via a media playing device, including a receiver for receiving an emergency broadcast transmission, wherein the emergency broadcast transmission contains at least one of emergency broadcast information and an emergency broadcast message, media playing equipment for providing the at least one of emergency broadcast information and an emergency broadcast message, and a control device for at least one of detecting a reception of the emergency broadcast transmission, monitoring an emergency broadcast transmission, and determining at least one of an operating state of the media playing equipment and an operating mode of the media playing equipment, and further wherein the control device at least one of activates the media playing equipment and switches the media playing equipment to an operating mode for providing the at least one of emergency broadcast information and an emergency broadcast message.

### FIELD OF THE INVENTION

The present invention pertains to an apparatus and method for providing emergency broadcast information via a media playing device and, in particular, to an apparatus and method for providing emergency broadcast information which detects an emergency broadcast transmission and which provides control over an operation of a media playing device in order to provide the emergency broadcast information or the emergency broadcast message via the media playing device.

### BACKGROUND OF THE INVENTION

The emergency broadcast system serves to provide information regarding emergencies to the general public. Many are familiar with the emergency messages or emergency broadcast test broadcasts which are designed, at least in part, to test or ascertain the readiness or preparedness of radio broadcast systems or television broadcast systems to convey emergency broadcasts messages to the general public.

Typically, these emergency messages or test broadcasts can be heard while listening to radios or while watching television.

The above-described emergency messages or test broadcasts, however, are not always carried by all of the radio stations or television stations which broadcast in a given area and, therefore, may be inadequate or insufficient for reaching all of the radio listeners or television viewers in a given area. Not every radio station or television station may transmit emergency broadcasts.

Another shortfall of the current emergency broadcasting system lies in the fact that a radio or television must be turned on, or else must be in a broadcast signal receiving mode of operation in order to receive and provide the emergency broadcast message or emergency broadcast information to the respective radio listener or television viewer. For example, if a vehicle operator or occupant has a vehicle radio turned off or is instead utilizing the compact disc player of the vehicle radio, he or she will not hear an emergency broadcast message.

As a result, it is submitted that many shortcomings exist in the broadcasting of, and the dissemination of, emergency broadcast information or messages.

### SUMMARY OF THE INVENTION

The present invention pertains to an apparatus and method for providing emergency broadcast information via a media playing device which overcomes the shortfalls of the prior art. The present invention provides an apparatus and method for providing emergency broadcast information which can detect an emergency broadcast and which can provide control over an operation of a media playing device in order to provide the emergency broadcast information or emergency broadcast message via the media playing device.

The present invention can be utilized in conjunction with any media playing device, communication device, or electronic equipment and/or accessory, in order to monitor and/or to detect an occurrence of an emergency broadcast transmission, to determine an operating status and/or an operating mode of the respective media playing device, and to control the operation of the respective media playing device in order to provide the emergency broadcast information or message via same.

The present invention can be utilized in order to provide emergency broadcast information or emergency broadcast messages via any type of media playing device or devices, such as, but not limited to, a vehicle radio, a radio, a radio tuner, a television, a cable television, a closed circuit television, an entertainment device, a stereo, a stereo system, a digital video disc playing device, a compact disc playing device, a cable television receiver, an MP3 player device, a computer, a communication device, a telephone, a wireless communication device, a wireless telephone, a cellular telephone, a pager, a walkie-talkie, a two-way radio, a radar detector, a global positioning device, a traffic message display device, and/or any other media playing device or communication device which can be adapted for providing emergency broadcast information or emergency broadcast messages.

The present invention can provide emergency broadcast information or emergency broadcast messages via any type or kind of device which can be adapted for receiving and providing the herein-described emergency broadcast information or emergency broadcast messages in the manner described herein.

The respective media playing device can be equipped with an appropriate receiver, processing device, an audio output device or speaker(s), and/or a video output device or display device, depending upon the type of media playing device utilized.

The present invention can be utilized in conjunction with radio signal communication networks or systems, satellite communication networks or systems, optical communication networks or systems, digital communication networks or systems, telecommunication-networks or systems, public switched telephone networks or systems, closed circuit broadcasting networks or systems, cable television broadcast networks or systems, the Internet, the World Wide Web, global positioning communication networks or systems, and/or any combination of same.

The apparatus of the present invention includes a media playing device which can be any one or more of the above-described media playing devices, including, but not limited to, a vehicle radio, a radio, a radio tuner, a television, a cable television, a closed circuit television, an entertainment device, a stereo, a stereo system, a digital video disc playing device, a compact disc playing device, a cable television receiver, an MP3 player device, a computer, a communication device, a telephone, a wireless communication device, a wireless telephone, a cellular telephone, a pager, a walkie-talkie, a two-way radio, a radar detector, a global positioning device, a traffic message display device, and/or any other media playing device or communication device which can be adapted for providing emergency broadcast information or emergency broadcast messages.

The apparatus can also include a media broadcast system or station which can be any appropriate broadcast system, broadcast station, central information dissemination system, central information dissemination station, telephone service provider, telecommunication service provider, Internet service provider, etc., which can provide service to, and/or broadcasts, to any of the respective media playing devices which can be utilized in conjunction with the present invention.

The apparatus can also include an emergency broadcast system or station which provides the broadcasts of the emergency broadcast information and/or emergency broadcast messages described herein. The emergency broadcasting system can be any suitable media broadcasting system which can interface with and/or which can operate in conjunction with the respective media broadcasting system. The emergency broadcasting system can also be a system which can interface with, and/or which can operate in conjunction with, any number of types or kinds of media broadcasting systems.

The emergency broadcast system can be any one or more of a radio station broadcasting system, a television broadcasting station, a cable television broadcasting system, a closed circuit television broadcasting system, a telephone service provider, a telecommunication service provider, an Internet Service Provider (ISP), or any other suitable broadcasting system. The emergency broadcasting system can also be a broadcasting system which can provide emergency broadcasts in conjunction with any combination or with any number of types or kinds of media broadcasting systems.

The apparatus of the present invention can operate over any suitable communication network or medium. The media broadcast system can transmit broadcasts to the media playing device via the communication network or medium. The emergency broadcasting system can transmit emergency broadcasts either to the media broadcast system for transmission relay to, or subsequent re-transmission to, the media playing device. The emergency broadcasting system can also transmit emergency broadcasts directly to the media playing device.

The media playing device can include the media playing equipment which can be and/or which can include all of the components, devices, and/or systems, which comprise the respective media playing device.

The media playing device can also include a media broadcast receiver which can be any suitable receiver or receiving device for receiving broadcast transmissions typically received during the normal operation or use of the respective media playing device.

The media playing device can also include a media source device which can be a storage medium for media which is to be provided with or via the media playing device.

The media playing device can also include an emergency broadcast receiver which can be dedicated or tuned for receiving emergency broadcast signals which contain emergency broadcast information or emergency broadcast messages. The emergency broadcast receiver can be the same type of device as the media broadcast receiver so as to receive and process the same types of transmissions and/or broadcasts which are or which may be normally associated with the respective media playing device.

The media playing device can also include an emergency broadcast control device which can be a control device which can be programmed and/or which can be adapted to detect and/or to monitor the receiving of emergency broadcast transmissions or signals by the emergency broadcast receiver. The emergency broadcast control device can perform processing routines for processing the emergency broadcast information or emergency broadcast messages as well as perform processing routines for controlling the operation of the media playing equipment in the manner described herein.

The emergency broadcast control device can an integral component of the media playing equipment or can be a separate device which can be utilized in conjunction with the media playing equipment.

The media playing device can also include an audio output device which can be a speaker, a plurality of speakers, or a speaker system, for providing audio information from the media playing device. The media playing device can also include a video output device such a display device or a display screen for providing video information from the media playing device.

The apparatus of the present invention can be utilized in order to detect and receive an emergency broadcast transmission and to determine an operating status of a media playing device so as to determine whether the media playing equipment is “on” or “off”.

If the media playing equipment is determined to be “off”, the apparatus can turn the media playing equipment “on”.

Once the media playing equipment is determined to be “on”, the apparatus can determine the operating mode of the media playing equipment.

The apparatus can determine if the media playing equipment is in a live broadcast operating mode so as to convey the live broadcast information or live broadcast message to the listener or viewer. If the apparatus determines that the media playing equipment is not in a live broadcast operating mode of operation, the apparatus can switch the media playing equipment to the a live broadcast operating mode.

Once the emergency broadcast message is completed or has terminated the apparatus can switch the media playing equipment to the operating mode and/or to the operating status that it was operating in, or not operating in, prior to the detection and receipt of the emergency broadcast transmission.

The present invention can be utilized in a same manner, in a similar manner, and/or an analogous manner, in order to provide emergency broadcast information or emergency broadcast messages via any appropriate or suitably adapted media playing device(s).

The present invention can be utilized in order to provide emergency broadcast information or emergency broadcast messages via the media playing device. The present invention can also provide for the interruption of an operation of the media playing device, or activate or turn “on” the media playing device if the media playing device is not operating or not being utilized, in order to provide emergency broadcast information or emergency broadcast messages.

The present invention can also provide for the restoring of the media playing device to its pre-emergency broadcast transmission operating state and/or to its pre-emergency broadcast transmission operating mode upon the completion or termination of an emergency broadcast transmission.

Accordingly, it is an object of the present invention to provide an apparatus and method for providing emergency broadcast information via a media playing device.

It is another object of the present invention to provide an apparatus and method for providing emergency broadcast information which can detect an emergency broadcast.

It is still another object of the present invention to provide an apparatus and method for providing emergency broadcast information which can monitor an emergency broadcast.

It is yet another object of the present invention to provide an apparatus and method for providing emergency broadcast information via a media playing device which can provide control over an operation of a media playing device in order to provide the emergency broadcast information via same.

It is another object of the present invention to provide an apparatus and method for providing emergency broadcast information via a media playing device which can be utilized in conjunction with any suitable media playing device, communication device, electronic equipment, and/or accessory.

It is still another object of the present invention to provide an apparatus and method for providing emergency broadcast information via a media playing device which can determine an operating status of the media playing device.

It is yet another object of the present invention to provide an apparatus and method for providing emergency broadcast information via a media playing device which can provide control over an operating status of the media playing device.

It is another object of the present invention to provide an apparatus and method for providing emergency broadcast information via a media playing device which can determine an operating mode of the media playing device.

It is still another object of the present invention to provide an apparatus and method for providing emergency broadcast information via a media playing device which can provide control over an operating mode of the respective media playing device.

It is yet another object of the present invention to provide an apparatus and method for providing emergency broadcast information via a media playing device which can provide control over an operating mode of the media playing device in order to switch the media playing device to a mode of operation for providing a live broadcast.

It is another object of the present invention to provide an apparatus and method for providing emergency broadcast information via a media playing device which can be utilized in conjunction with any suitable and/or suitably adapted media playing device, communication device, computer device, and/or electronic device or accessory.

It is still another object of the present invention to provide an apparatus and method for providing emergency broadcast information via a media playing device which can be utilized on or over any suitable communication network or medium.

It is yet another object of the present invention to provide an apparatus and method for providing emergency broadcast information via a media playing device which can determine if the media playing device is on or off.

It is another object of the present invention to provide an apparatus and method for providing emergency broadcast information via a media playing device which can provide control over the media playing device so as to turn it on to provide the emergency broadcast information.

It is still another object of the present invention to provide an apparatus and method for providing emergency broadcast information via a media playing device which can provide control over the media playing device so as to return it to a previously determined off state after the emergency broadcast information has been provided.

It is yet another object of the present invention to provide an apparatus and method for providing emergency broadcast information via a media playing device which can determine if the media playing device is in an operating mode for providing a live broadcast.

It is another object of the present invention to provide an apparatus and method for providing emergency broadcast information via a media playing device which can provide control over the media playing device so as to switch it to an operating mode for providing the live emergency broadcast information.

It is still another object of the present invention to provide an apparatus and method for providing emergency broadcast information via a media playing device which can provide control over the media playing device so as to return it to a previously determined operating mode after the emergency broadcast information has been provided.

It is yet another object of the present invention to provide an apparatus and method for providing emergency broadcast information via a media playing device which can interrupt an operation of the media playing device in order to provide the emergency broadcast information via same.

It is another object of the present invention to provide an apparatus and method for providing emergency broadcast information via a media playing device which can restore the media playing device to its pre-emergency broadcast transmission operating state and/or to pre-emergency broadcast transmission operating mode upon the completion or termination of an emergency broadcast transmission.

Other objects and advantages of the present invention will be apparent to those skilled in the art upon a review of the Description of the Preferred Embodiments taken in conjunction with the Drawings which follow.

### BRIEF DESCRIPTION OF THE DRAWINGS

In the Drawings:

FIG. 1 illustrates a preferred embodiment of the apparatus of the present invention, in block diagram form;

FIG. 2 illustrates the media playing device of FIG. 1, illustrating the components thereof, in block diagram form; and

FIGS. 3A and 3B illustrate a preferred embodiment method for utilizing the apparatus of FIG. 1, in flow diagram form.

### DESCRIPTION OF THE PREFERRED EMBODIMENTS

The present invention pertains to an apparatus and method for providing emergency broadcast information via a media playing device and, in particular, to an apparatus and method for providing emergency broadcast information which can detect an emergency broadcast transmission and which can provide control over an operation of a media playing device in order to provide the emergency broadcast information or the emergency broadcast message via the media playing device.

The apparatus and method of the present invention can be utilized in conjunction with any media playing device, communication device, electronic equipment and/or accessory, (hereinafter referred to collectively as “media playing device”), in order to monitor and/or to detect an occurrence of an emergency broadcast transmission, to determine an operating status and/or an operating mode of the respective media playing device, and to control the operation of the respective media playing device in order to provide the emergency broadcast information or message via the media playing device.

The apparatus and method of the present invention can be utilized in order to provide emergency broadcast information or emergency broadcast messages via any type of media playing device or devices, such as, but not limited to a vehicle radio, a radio, a radio tuner, a television, a cable television, a closed circuit television, an entertainment device, a stereo, a stereo system, a digital video disc playing device, a compact disc playing device, a cable television receiver, an MP3 player device, a computer, a communication device, a telephone, a wireless communication device, a wireless telephone, a cellular telephone, a pager, a walkie-talkie, a two-way radio, a radar detector, a global positioning device, a traffic message display device, and/or any other media playing device or communication device which can be adapted for providing emergency broadcast information or emergency broadcast messages.

The present invention can provide emergency broadcast information or emergency broadcast messages via any type or kind of device which can be adapted for receiving and providing the herein-described emergency broadcast information or emergency broadcast messages in the manner described herein.

It is important to note that each of the herein-described types or kinds of media playing devices can be capable and/or can be adapted for receiving any of the broadcasts and emergency broadcasts which are provided by any of the herein-described media broadcast systems and emergency broadcast systems. In this regard, each respective media playing device can be equipped with an appropriate receiver, processing device, an audio output device or speaker(s), and/or a video output device or display device, depending upon the type of media playing device utilized.

The apparatus and method of the present invention can be utilized in conjunction with radio signal communication networks or systems, satellite communication networks or systems, optical communication networks or systems, digital communication networks or systems, telecommunication networks or systems, public switched telephone networks or systems, closed circuit broadcasting networks or systems, cable television broadcast networks or systems, the Internet, the World Wide Web, global positioning communication networks or systems, and/or any combination of same.

As used herein, the term “media playing device”, or the plural of same, refers to any vehicle radio(s), radio(s), radio tuner(s), television(s), cable television(s), closed circuit television(s), entertainment device(s), stereo(s), stereo system(s), digital video disc playing device(s), compact disc playing device(s), cable television receiver(s), MP3 player device(s), computer(s), communication device(s), telephone(s), wireless communication device(s), wireless telephone(s), cellular telephone(s), pager(s), walkie-talkie(s), two-way radio(s), radar detector(s), global positioning device(s), traffic message display device(s), and/or any other media playing device(s) or communication device(s) which can be adapted for providing emergency broadcast information or emergency broadcast messages.

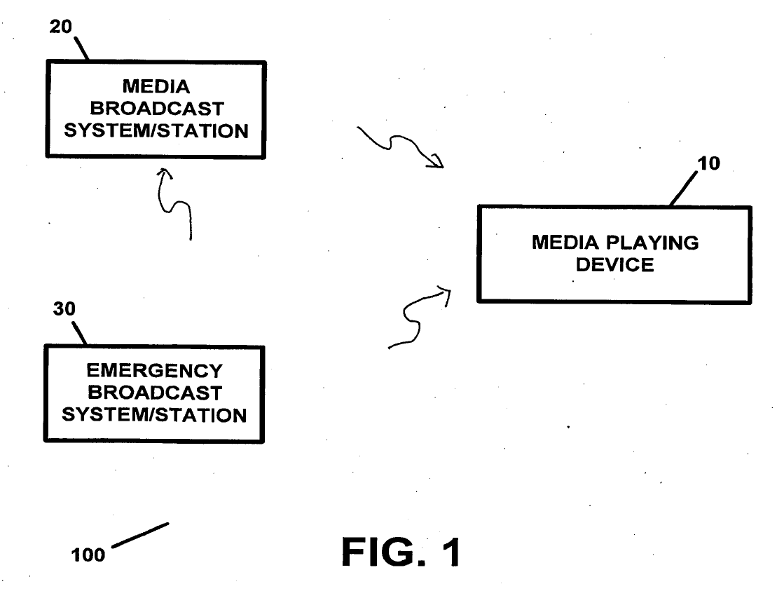

FIG. 1 illustrates a preferred embodiment of the apparatus of the present invention, which is designated generally by the reference numeral 100, in block diagram form.

With reference to FIG. 1, the apparatus 100 includes a media playing device 10. As noted above, the media playing device 10 can be any one or more of the above-described media playing devices, including, but not limited to, a vehicle radio, a radio, a radio tuner, a television, a cable television, a closed circuit television, an entertainment device, a stereo, a stereo system, a digital video disc playing device, a compact disc playing device, a cable television receiver, an MP3 player device, a computer, a communication device, a telephone, a wireless communication device, a wireless telephone, a cellular telephone, a pager, a walkie-talkie, a two-way radio, a radar detector, a global positioning device, a traffic message display device, and/or any other media playing device or communication device which can be adapted for providing emergency broadcast information or emergency broadcast messages.

The apparatus 100 can also include a media broadcast system or station 20 (hereinafter referred to “media broadcast system 20”). The media broadcast system 20 can be any appropriate broadcast system, broadcast station, radio station, television station, cable television station, central information dissemination system, central information dissemination station, telephone service provider, telecommunication service provider, Internet service provider, etc., which can provide service to and/or broadcasts to any respective media playing devices 10 which are utilized in conjunction with the apparatus 100.

For example, for a media playing device 10 such as a vehicle radio, a radio, a radio tuner, a stereo, or other entertainment device(s), the media broadcast system can be a radio station broadcasting system. For a media playing device 10 such as a television(s), or other entertainment device(s), the media broadcasting system 20 can be a television broadcasting station. For a media playing device 10 such as a cable television, a closed circuit television, or other entertainment device(s), the media broadcasting system 20 can be a cable television broadcasting system or a closed circuit television broadcasting system.

For a media playing device 10 such as a computer, a digital video disc playing device, a compact disc playing device, an MP3 player device, a telephone, a wireless communication device, a wireless telephone, a cellular telephone, a pager, a walkie-talkie, or a traffic message display device, etc., the media broadcasting system 20 can be an Internet Service Provider (ISP).

For a media playing device 10 such as a communication device, a telephone, a wireless communication device, a wireless telephone, a cellular telephone, a pager, a walkie-talkie, or a two-way radio, a radar detector, or a traffic message display device, the media broadcasting system 20 can be a telephone service provider or telecommunication service provider.

For a media playing device 10, such as a global positioning device, or a traffic message display device, the media broadcasting system 20 can be any broadcasting system adapted for providing broadcasts to the respective media playing device(s) 10.

With reference to FIG. 1, the apparatus 100 can also include an emergency broadcast system or station 30 (hereinafter referred to as “emergency broadcast system 30”). The emergency broadcast system 30 provides the broadcast transmissions of the emergency broadcast information and/or emergency broadcast messages described herein as being provided by the apparatus 100 and method of the present invention. The emergency broadcasting system 30 can be any suitable media broadcasting system which can interface with and/or which can operate in conjunction with the respective media broadcasting system 20.

The emergency broadcasting system 30 can also be a system which can interface with, and/or which can operate in conjunction with, any number of types or kinds of media broadcasting systems 20. In this regard, the emergency broadcasting system 30 can be any one or more of a radio station broadcasting system, a television broadcasting station, a cable television broadcasting system, a closed circuit television broadcasting system, a telephone service provider, a telecommunication service provider, an Internet Service Provider (ISP), or any other suitable broadcasting system.

The emergency broadcasting system 30 can also be a broadcasting system which can provide emergency broadcast transmissions in conjunction with any combination or with any number of types or kinds of media broadcasting systems 20. For example, the emergency broadcasting system 30 can be a system which can be adapted to provide emergency broadcast transmissions to radio stations, television stations, cable television stations, and Internet Service Providers, so that the respective emergency broadcast transmissions can be transmitted to any of the herein-described media playing devices 10.

With reference once again to FIG. 1, the apparatus 100 can operate over any suitable communication network or medium. The media broadcast system 20 can transmit broadcasts to the media playing device 10 via the communication network or medium. The emergency broadcasting system 30 can transmit emergency broadcasts either to the media broadcast system 20 for transmission relay to, or subsequent re-transmission to, the media playing device 10. The emergency broadcasting system 30 can also transmit emergency broadcasts directly to the media playing device 10.

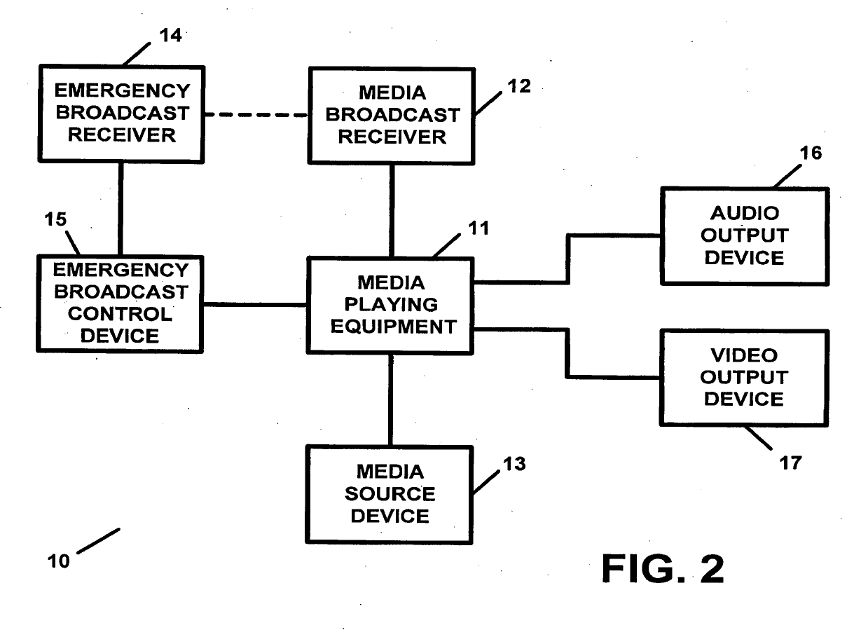

FIG. 2 illustrates a preferred embodiment of the media playing device 10 of FIG. 1, illustrating the components thereof, in block diagram form. With reference to FIG. 2, the media playing device 10 includes media playing equipment 11. The media playing equipment 11 can be and/or can include any and/or all of the components, devices, and/or systems, which comprise the respective media playing device 10.

For example, for a media playing device 10 which is a radio, a vehicle radio, a stereo, or other similar device, the media playing equipment 11 can include an antenna or receiver, a tuner device or turner circuitry, a pre-amplifier, an amplifier, a power supply or power source, a power control device or power control circuitry, a frequency tuning device or frequency tuning circuitry, a volume control device or volume control circuitry, and an output device(s) such as speakers, etc. In the case of a media playing device 10 such as a vehicle radio, stereo, or entertainment center, which can include an auxiliary device(s) such as a compact disc (CD) player, a tape player, a digital versatile disc (DVD) player, etc., the media playing equipment 11 can also include the respective compact disc player, a tape player, a digital versatile disc player, etc.

As another example, for a media playing device 10 which is a television, or other similar device, the media playing equipment 11 can include an antenna or receiver, a tuner device or turner circuitry, a pre-amplifier, an amplifier, a power supply or power source, a power control device or power control circuitry, a video signal processing device or circuitry, a channel selection device, a tuning device, a channel selection or tuning circuitry, a volume control device or volume control circuitry, a video output device or circuitry, and an output device(s), such as display screen, speakers, etc.

In the case of a media playing device 10 which is a television equipped with a video cassette player/recorder, digital versatile disc player, or other auxiliary device, etc., the media playing equipment 11 can include the respective video cassette player/recorder, digital versatile disc player, or other auxiliary device, etc.

In a similar manner, any of the herein-described media playing devices 10 can have any of the respective media playing equipment 11 which is associated with the respective media playing device 10. In this regard, media playing devices 10 such as, but not limited to, a computer, a communication device, a wireless telephone, etc., can include as media playing equipment 11, any and/or all of the components, devices, and systems, which are typically utilized and/or comprise such devices as well as any additional components, devices, and/or equipment, which are or which may be utilized in order to receive and provide any of the herein-described emergency broadcast information or emergency broadcast messages.

With reference once again to FIG. 2, the media playing device 10 can include a media broadcast receiver 12 which can be any suitable receiver or receiving device for receiving broadcast transmissions which are typically received during the normal operation or use of the respective media playing device 10. For example, for a radio or a vehicle radio, the media broadcast receiver 12 can include an antenna as well as a receiver or receiver device for receiving and/or processing the broadcast transmissions or signals which are transmitted from the broadcast system 20. The media broadcast receiver 12 can be linked to the media playing equipment 11.

The media playing device 10 can also include a media source device 13 which can, for example be a cassette tape, or a compact disc, which can be a storage medium for media which can be provided with or via the media playing device 10. The media source device 13 can also be linked to the media playing equipment 11.

The media playing device 10 can also include an emergency broadcast receiver 14 which can be dedicated or tuned for receiving emergency broadcast transmissions or signals which contain emergency broadcast information or emergency broadcast messages. In the preferred embodiment, the emergency broadcast receiver 14 can be of the same type as the media broadcast receiver 12 so as to receive and process the same types of transmissions and/or broadcasts which are normally associated with the respective media playing device 10. In the preferred embodiment, the emergency broadcast receiver 14 can be capable of interfacing with the media broadcast receiver 12.

The emergency broadcast receiver 14 can be linked to the media broadcast receiver 12. In one preferred embodiment, the media playing device 10 can include a separate media broadcast receiver 12 and a separate emergency broadcast receiver 14. In another preferred embodiment, the media broadcast receiver 12 and the emergency broadcast receiver 14 can be integrated into the same device and/or can be implemented by or with a single receiver or receiver system which can receive and process the respective signals.

With reference once again to FIG. 2, the media playing device 10 can include an emergency broadcast control device 15. The emergency broadcast control device 15 is linked to the emergency broadcast receiver 14. The emergency broadcast control device 15 is a control device which can be programmed and/or which can be adapted to detect and/or to monitor the receiving of emergency broadcast transmissions or signals by the emergency broadcast receiver 14. The emergency broadcast control device 15 is also linked to the media playing equipment 11 and can perform processing routines for processing the emergency broadcast information or emergency broadcast messages as well as perform processing routines for providing control over the operation of the media playing equipment 11 in the manner described herein.

In the preferred embodiment, the emergency broadcast control device 15 can be an integral component of the media playing equipment 11 and/or the media playing device 10. In another preferred embodiment, the emergency broadcast receiver 14 and the emergency broadcast control device 15 can be integral components of the media playing equipment 11 and/or the media playing device 10. In another preferred embodiment, the emergency broadcast control device 15 or the emergency broadcast receiver 14/emergency broadcast control device 15 combination can be a modular device or an external device which can be connected to and/or affixed to the media playing equipment 11 and/or the media playing device 10.

For example, an emergency broadcast receiver 14/emergency broadcast control device 15 combination device can be an attachable external peripheral device for a computer, a wireless telephone, and/or any of the other herein-described media playing devices 10. The emergency broadcast receiver 14/emergency broadcast control device 15 combination device can also be removably attached to the respective media playing device 10.

The emergency broadcast receiver 14 and the emergency broadcast control device 15 can be powered by the power source of the media playing equipment 11, and/or by an external power source, so as to ensure that sufficient power is provided to the emergency broadcast receiver 14 and the emergency broadcast control device 15, in a continuous and an uninterrupted manner, regardless of the operating state (i.e., power “on” or power “off”) or operating mode of the media playing device 10 or the media playing equipment 11.

With reference to FIG. 2, the media playing device 10 can also include an audio output device 16 which can be a speaker, a plurality of speakers, or a speaker system, for providing audio information from the media playing device 10. The audio output device 16 can also be linked to the media playing equipment 11.

The media playing device 10 can also include a video output device such a display device or a display screen for providing video information from the media playing device 10. The video output device 17 can also be linked to the media playing equipment 11.

The apparatus 100 and method of the present invention can be utilized in order to provide emergency broadcast information or an emergency broadcast message via the media playing device 10. The apparatus 100 of the present invention and/or the emergency broadcast control device 15 can be utilized in order to detect and receive an emergency broadcast transmission or signal and to determine an operating status of the media playing device 10 so as to determine whether the media playing device 10 is “on” or “off”.

If the media playing device is determined to be “off”, the apparatus 100 and/or the emergency broadcast control device 15 can turn the media playing device 10 “on”. Once the media playing device 10 is determined to be “on”, the apparatus 100 and/or the emergency broadcast control device 15 can determine the operating mode of the media playing device 10.

The apparatus 100 and/or the emergency broadcast control device 15 can determine if the media playing device 10 is operating in a live broadcast operating mode so as to be capable of conveying the live broadcast information or live broadcast message to the listener or viewer. As an illustrative example, the apparatus 100 and/or the emergency broadcast control device 15 can determine whether a vehicle radio is being utilized so as to play a compact disc (CD) player, thereby indicating that the radio tuner is or may be in the “off” mode.

As another illustrative example, the apparatus 100 and/or the emergency broadcast control device 15 can determine whether a television is in a live broadcast mode, so as to provide a live broadcast, or whether the television is being utilized so as to view a taped show such as with a tape player or with a video cassette recorder/player.

If the apparatus 100 and/or the emergency broadcast control device 15 determines that the media playing device 10 is not operating in a live broadcast operating mode, the apparatus 100 and/or the emergency broadcast control device 15 can switch the media playing device 10 to a live broadcast operating mode.

For example, if a vehicle radio is being utilized to play a compact disc at the time an emergency broadcast transmission is received, the apparatus 100 and/or the emergency broadcast control device 15 can switch the vehicle radio to the live radio mode so as to allow the radio to broadcast the emergency broadcast information or emergency broadcast message. In a similar manner, if a television is being utilized to play a digital versatile disc (DVD) at the time an emergency broadcast transmission is received, the apparatus 100 and/or the emergency broadcast control device 15 can switch the television to the live television broadcast operating mode so as to allow the television to broadcast the emergency broadcast information or emergency broadcast message.

Once the emergency broadcast message is completed or has terminated, the apparatus 100 and/or the emergency broadcast control device 15 can switch the media playing device 10 to the operating mode and/or to the operating status in which it was operating, or not operating, prior to the detection and reception of the emergency broadcast transmission.

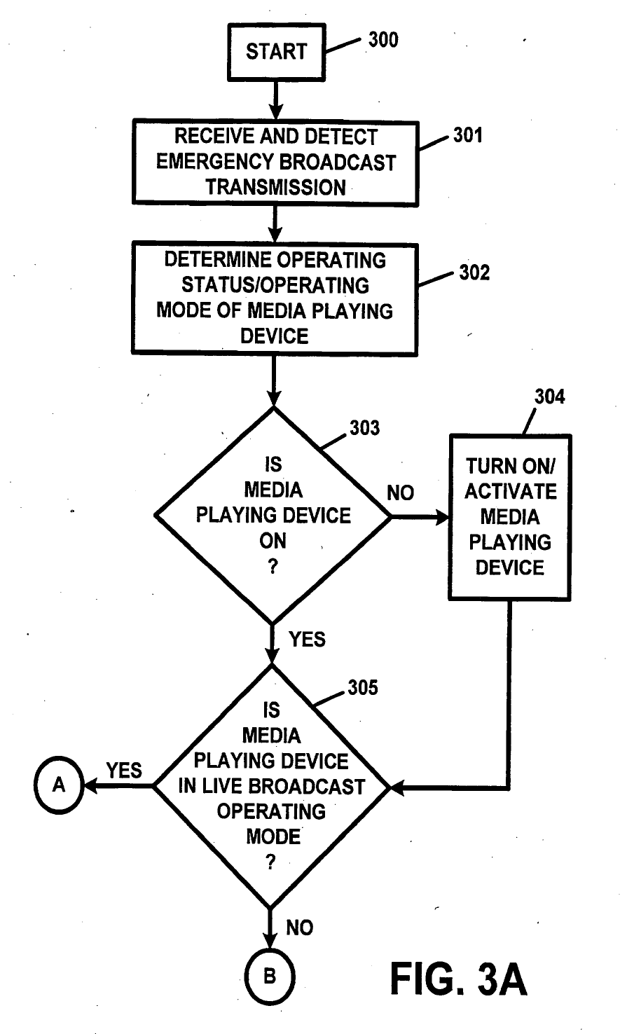

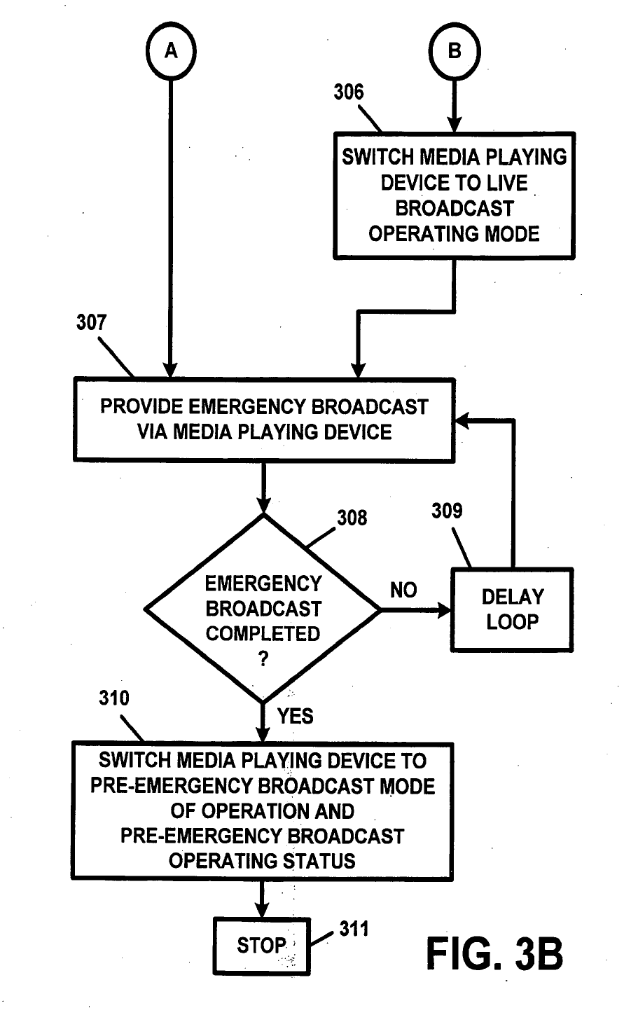

FIGS. 3A and 3B illustrate a preferred embodiment method for utilizing the apparatus 100 of FIG. 1, in flow diagram form. The preferred embodiment method for utilizing the apparatus 100 of the present invention, as described and illustrated in FIGS. 3A and 3B, describes a use of the apparatus 100 in conjunction with a vehicle radio as the media playing device 10. It is to be understood, however, that the embodiment of FIGS. 3A and 3B can be utilized in the same, a similar, and/or an analogous manner, with any one or more of the herein-identified and/or herein-described media playing devices 10 with which the apparatus 100 and method of the present invention can be utilized.

With reference to FIGS. 3A and 3B, the operation of the apparatus 100 commences at step 300. Upon commencement of the operation of the apparatus 10, the media playing device 10 or the vehicle radio can either be “on” or “off” and/or can be in a live broadcast mode of operation or in any other auxiliary mode of operation (i.e. compact disc playing operating mode, cassette tape playing operating mode, etc.).

Upon an occurrence of an event which gives rise to a transmission of an emergency broadcast transmission or signal from the emergency broadcast system 30, the emergency broadcast system 30 can transmit the emergency broadcast transmission containing the emergency broadcast information or emergency broadcast message.

The emergency broadcast transmission can be transmitted to the media playing device 10 from the emergency broadcast system 30 and/or from the media broadcasting system 20. The emergency broadcast transmission can also be transmitted to the media playing device 10 from the emergency broadcast system 30 via the media broadcasting system 20.

At step 301, the emergency broadcast receiver 14 can receive the emergency broadcast transmission containing the emergency broadcast information or emergency broadcast message. At step 301, the emergency broadcast control device 15 will detect the reception of the emergency broadcast transmission.

At step 302, the emergency broadcast control device 15 will determine and/or ascertain the operating status of the media playing device 10 or the vehicle radio so as determine if the vehicle radio is “on” or “off”. At step 302, the emergency broadcast control device 15 will also determine and/or ascertain the operating mode of the media playing device 10 or the vehicle radio so as to determine whether the vehicle radio in the live radio broadcast mode, wherein it can provide the live radio broadcast received from a media broadcast system 20 or an emergency broadcast system 30, or whether it is operating an auxiliary mode of operation, wherein it is being utilized in a cassette tape player operating mode or a compact disc player operating mode.

The emergency broadcast control device 15 will also, at step 302, store information regarding the determined operating status and operating mode of the media playing device 10 or vehicle radio. The stored operating status and operating mode are indicative of the operating status and the operating mode of the media playing device 10 at the time the emergency broadcast transmission is detected by the media playing device 10 and/or by the emergency broadcast receiver 14.

At step 303, the emergency broadcast control device 15 can determine whether the media playing device 10 or the vehicle radio is “on”. If at step 303, it is determined that the media playing device 10 or the vehicle radio is “off”, the emergency broadcast control device 15 can, at step 304, transmit a power “on” signal to the media playing equipment 11 so as to turn the media playing equipment 11 or the vehicle radio “on”.

Thereafter, the operation of the apparatus 100 will proceed to step 305. If at step 303, it is determined that the media playing device 10 or the vehicle radio is “on”, the operation of the apparatus 100 will processed directly to step 305.

At step 305, the emergency broadcast control device 15 will determine whether the media playing device 10 or the vehicle radio is in a live broadcast operating mode. In the live broadcast operating mode, the media playing device 10 or the vehicle radio receives and provides broadcast transmissions from the media broadcasting system 20 and/or from the emergency broadcast system 30.

If, at step 305, it is determined that the media playing device 10 or the vehicle radio is not in a live broadcast operating mode, such as, for example, that the vehicle radio is in a cassette tape playing operating mode or in a compact disc playing operating mode, then the operation of the apparatus 100 will proceed to step 306 and the emergency broadcast control device 15 will transmit a “live broadcast” control signal to the media playing equipment 11 of the vehicle radio so as to switch the vehicle radio to a live radio broadcast operating mode. Thereafter, the operation of the apparatus will proceed to step 307.

If, at step 305, it is determined that the media playing device 10 or the vehicle radio is already in a live broadcast radio operating mode, then the operation of the apparatus 100 will proceed directly to step 307.

At step 307, the emergency broadcast control device 15 can provide the emergency broadcast information or emergency broadcast message to the media playing equipment 11 of the media playing device 10 or vehicle radio and, thereafter, at step 307, the emergency broadcast information or emergency broadcast message can be provided via the media playing device 10 or vehicle radio. In this manner, the emergency broadcast information or emergency broadcast message can be provided to the listener via the media playing device 10 or vehicle radio.

The emergency broadcast information or emergency broadcast message will continue to be provided via the media playing device 10 or vehicle radio until the emergency broadcast transmission is completed or has terminated.

At step 308, the emergency broadcast control device 15 can determine whether the emergency broadcast transmission is completed or has terminated. If, at step 308, the emergency broadcast control device 15 determines that the emergency broadcast transmission is not completed, or has not terminated, the operation of the apparatus 100 will enter a delay loop, at step 309, for a predetermined time period of, for example, one (1) second, after which the test at step 308 can be repeated.

The above described operation of steps 308 and 309 will be repeated until the emergency broadcast control device 15 determines that the emergency broadcast is completed at step 308.

Upon determining, at step 308, that the emergency broadcast transmission is completed, or has terminated, the emergency broadcast control device 15 can, at step 310, utilize the information regarding the pre-emergency broadcast operating status and the pre-emergency broadcast operating mode in order to restore the media playing device 10 or vehicle radio to its pre-emergency broadcast operating status and pre-emergency broadcast operating status.

At step 310, the emergency broadcast control device 15 can generate and transmit an appropriate operating status control signal to the media playing equipment 11 so as to maintain the media playing device 10 in the “on” operating state if it was previously determined to be in the “on” operating state at step 302, or generate and transmit an appropriate control signal to turn the media playing equipment 11 “off” if it was determined to be in the “off” operating state at step 302.

At step 310, the emergency broadcast computer 15 can also generate and transmit an appropriate operating mode control signal to the media playing equipment 11 so as to restore the media playing device 10 or the vehicle radio to its pre-emergency broadcast operating mode, determined at step 302. For example, if the vehicle radio was being utilized in a cassette tape player mode of operation or in a compact disc player mode of operation at the time the emergency broadcast transmission was received, the emergency broadcast computer 15 can generate and transmit an operating mode control signal to the media playing equipment 11 so as to switch or return the media playing device 10 or the vehicle radio to the respective cassette tape player mode of operation or to the compact disc player mode of operation.

If, at step 302, the emergency broadcast computer 15 determined that the media playing device 10 or the vehicle radio was in a live radio broadcast operating mode, then, at step 310, the emergency broadcast computer 15 can generate and transmit an appropriate operating mode control signal to the media playing equipment 11 so as to switch or return the media playing device 10 or the vehicle radio to the live radio broadcast operating mode and/or to the radio station or tuned broadcast frequency which was being received prior to the emergency broadcast transmission interruption.

Upon the completion of step 310, the operation of the apparatus 100 will cease at step 311. Thereafter, the above-described operation can be repeated upon the occurrence of a next emergency broadcast transmission.

The apparatus 100 and method of the present invention can be utilized in a same manner, in a similar manner, and/or an analogous manner, in order to provide emergency broadcast information or emergency broadcast messages via any of the herein-identified media playing devices 10.

In the above-described manner, the apparatus 100 and method of the present invention can be utilized in order to provide emergency broadcast information or emergency broadcast messages via the media playing device 10. The apparatus 100 and method of the present invention can also provide for the interruption of an operation of the media playing device 10, or activate or turn “on” the media playing device 10 if the media playing device 10 is not operating or not being utilized, in order to provide emergency broadcast information or emergency broadcast messages.

The apparatus 100 and method of the present invention can also provide for the restoring of the media playing device to its pre-emergency broadcast transmission operating state and/or to its pre-emergency broadcast transmission operating mode upon the completion or termination of an emergency broadcast transmission.

While the present invention has been described and illustrated in various preferred and alternate embodiments, such descriptions are merely illustrative of the present invention and are not to be construed to be limitations thereof. In this regard, the present invention encompasses all modifications, variations, and/or alternate embodiments, with the scope of the present invention being limited only by the claims which follow.

1. An apparatus for providing emergency broadcast information via a media playing device, comprising: a receiver for receiving an emergency broadcast transmission, wherein the emergency broadcast transmission contains at least one of emergency broadcast information and an emergency broadcast message; media playing equipment for providing the at least one of emergency broadcast information and an emergency broadcast message; and a control device for at least one of detecting a reception of the emergency broadcast transmission, monitoring an emergency broadcast transmission, and determining at least one of an operating state of the media playing equipment and an operating mode of the media playing equipment, and further wherein the control device at least one of activates the media playing equipment and switches the media playing equipment to an operating mode for providing the at least one of emergency broadcast information and an emergency broadcast message.

2. The apparatus of claim 1, further comprising: a media broadcast receiver for receiving media transmitted from a media broadcasting system, wherein the media is provided by the media playing equipment in an operating mode.

3. The apparatus of claim 1, further comprising: a media source device for storing media provided by the media playing equipment in an operating mode.

4. The apparatus of claim 1, further comprising: an audio output device for providing audio information provided by the media playing equipment.

5. The apparatus of claim 1, further comprising: a video output device for providing video information provided by the media playing equipment.

6. The apparatus of claim 1, wherein the media playing equipment is a vehicle radio.

7. The apparatus of claim 1, wherein the media playing equipment is a radio.

8-59. (canceled)

60. An apparatus for providing emergency broadcast information via a media playing device, comprising: a receiver for receiving an emergency broadcast transmission, wherein the emergency broadcast transmission contains at least one of emergency broadcast information and an emergency broadcast message; media playing equipment for providing the at least one of emergency broadcast information and an emergency broadcast message, wherein the media playing equipment is a vehicle radio; and a control device for at least one of detecting a reception of the emergency broadcast transmission, monitoring an emergency broadcast transmission, and determining at least one of an operating state of the media playing equipment and an operating mode of the media playing equipment, and further wherein the control device at least one of activates the media playing equipment and switches the media playing equipment to an operating mode for providing the at least one of emergency broadcast information and an emergency broadcast message.

61. The apparatus of claim 60, further comprising: a media broadcast receiver for receiving media transmitted from a radio broadcasting station, wherein the media is provided by the media playing equipment in a radio operating mode.

62. The apparatus of claim 60, further comprising: a media source device for storing media provided by the media playing equipment in an operating mode, wherein the media source is at least one of a cassette tape and a compact disc.

63. The apparatus of claim 60, further comprising: an audio output device for providing audio information provided by the media playing equipment, wherein the audio output device is at least one of a speaker and a speaker system.

64. The apparatus of claim 60, wherein the media playing equipment further comprises a cassette tape player.

65. The apparatus of claim 60, wherein the media playing equipment further comprises a compact disc player.

65. The apparatus of claim 60, wherein the apparatus is utilized in conjunction with a radio signal communication network.

66-83. (canceled)

84. A method for providing emergency broadcast information via a media playing device, comprising: receiving an emergency broadcast transmission, wherein the emergency broadcast transmission contains at least one of emergency broadcast information and an emergency broadcast message; providing the at least one of emergency broadcast information and an emergency broadcast message via media playing equipment; at least one of detecting a reception of the emergency broadcast transmission, monitoring an emergency broadcast transmission, and determining at least one of an operating state of the media playing equipment and an operating mode of the media playing equipment; and at least one of activating the media playing equipment and switching the media playing equipment to an operating mode for providing the at least one of emergency broadcast information and an emergency broadcast message.

85. The method of claim 84, further comprising: receiving media transmitted from a media broadcasting system, wherein the media is provided by the media playing equipment in an operating mode.

86. The method of claim 84, further comprising: providing stored media via the media playing equipment in an operating mode.

87. The method of claim 84, further comprising: providing audio information via the media playing equipment.

88. The method of claim 84, further comprising: providing video information via the media playing equipment.

89. The method of claim 84, wherein the media playing equipment is a vehicle radio.

90-162. (canceled)
